(19) United States
(12) Patent Application Publication
(10) Pub. No.: US 2002/0150752 A1
(43) Pub. Date: Oct. 17, 2002

(54) Process for manufacturing a composite tape formed from reinforcing fibres and fibres of a thermoplastic organic material

(75) Inventors: Jean-Paul Debalme, Chambery (FR); Jacques Voiron, St. Jean De Couz (FR); Alexandre Cividino, Chambery (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Vetrotex France S.A., Chambery (FR)

(21) Appl. No.: 10/176,622

(22) Filed: Jun. 24, 2002

Related U.S. Application Data
(62) Division of application No. 09/668,291, filed on Sep. 25, 2000.

(30) Foreign Application Priority Data
Oct. 20, 1999 (FR) 99/13067

(51) Int. Cl. B29C 70/52; B29C 70/56; B28B 5/00

(52) U.S. Cl. 428/343; 264/136; 264/171.13; 425/115; 425/363

(57) ABSTRACT

Process for manufacturing a composite tape (10), consisting in bringing together and in consolidating a multiplicity of continuous yarns (11), characterized in that yarns (11) based on a thermoplastic and on reinforcing fibers are entrained and brought together in a parallel manner in the form of a sheet (12) which enters a zone in which it is heated to a temperature reaching at least the melting point of the thermoplastic and then passes through a rotating impregnation device (80) in order to distribute the molten thermoplastic uniformly and guarantee that the reinforcing fibers are completely impregnated by the latter; next, the sheet (12) is introduced into a shaping and centering device (100) so as to obtain a tape (13) formed by bringing the yarns (11) together so as to be touching, thereby creating transverse continuity; the tape (13) is cooled in order to consolidate the yarns by freezing the thermoplastic and its dimensional characteristics and its appearance are set in order to deliver the said composite tape (10).

The invention relates to the manufacture of a composite tape based on reinforcing fibres and on a thermoplastic organic material.

Composites based on a thermoplastic and on reinforcing fibres are widely used in the reinforcement of all types of articles, especially for the manufacture of composite pipes intended for conveying pressurized gases or liquids.

Patent Application FR 2,516,441 discloses a process for manufacturing thin sections comprising unidirectional continuous glass fibres embedded in a thermoplastic resin.

The steps of the process for obtaining such sections are as follows:

unwinding glass yarns from reels, in order to form a sheet of yarns;

separating the fibres of the yarns, in order to separate them because of the size with which they are coated;

dipping the sheet of glass fibres into an aqueous bath of a thermoplastic or else in a fluidized bed of powder of a thermoplastic;

heating the sheet in order to evaporate the water or to melt the powder, depending on the mode of dipping;

hot shaping the resin-encapsulated sheet of fibres so as to produce the desired section.

One drawback with this process is that it is necessary, in order for the fibres to be uniformly impregnated with the thermoplastic, to introduce the step of separating the fibres. This requires a specific device using several rollers, the number and arrangement of which, for ensuring the suitable winding angle of the sheet on these rollers, are determined by the degree to which the fibres stick together.

In addition, it is sometimes necessary, when the degree of sticking is too high, to provide heating means complementary to the rollers.

Consequently, there is a possibility that all the fibres are not completely separated from each other, in order subsequently to allow them to be encapsulated with the thermoplastic.

Moreover, the process uses for the impregnation a bath of thermoplastic which has to be maintained at a constant level the dispersion of which thermoplastic is constantly circulated in order to ensure as constant an impregnation as possible. Furthermore, the means employed in this bath are considerable and difficult to manage in a manufacturing line; these are elements such as a liquid delivery pump, a weir for establishing a constant level, a storage bath for the overflow, and a stirring device for ensuring that the contents of the bath are homogeneous, these elements having to be regularly cleaned.

In the variant of the impregnation device for the use of a fluidized bed, specific means are also necessary, especially a vibrating system mounted on springs, for metering the amount of powder taken away by the fibres.

Finally, the shaping device consists of a lower roller provided with a groove through which the sheet runs and of an upper roller serving to press the sheet. Thus, the various expected gauges of the section entail the drawback of having to have available several rollers which have variously sized grooves, respectively.

Consequently, this process, being slow to carry out, proves to be expensive and of low performance.

The object of the present invention is therefore to provide a process for manufacturing a composite based on reinforcing fibres and on a thermoplastic organic material, which process is easy and rapid to implement and is economic from an industrial standpoint.

More particularly, the invention provides, by virtue of this process, a product in the form of a strong flexible tape having a constant thickness of less than 0.2 mm and consisting of continuous reinforcing yarns arranged so as to be parallel and touching each other and consolidated by thermoplastic in order to create transverse continuity without any air being present, the tape having a smooth surface appearance and a void content of less than 0.2%.

According to the invention, the process for manufacturing the tape is characterized in that:

yarns based on thermoplastic and reinforcing fibres are entrained and brought together in a parallel manner in the form of a sheet;

the said sheet is made to enter a zone in which it is heated to a temperature reaching at least the melting point of the thermoplastic without reaching the softening temperature of the reinforcing fibres;

the sheet is made to pass through a rotating impregnation device, while maintaining its temperature at a temperature at which the thermoplastic is malleable, in order to distribute the molten thermoplastic uniformly and guarantee that the reinforcing fibres are completely impregnated by the latter;

the sheet is introduced into a shaping and centring device, while maintaining its temperature at a temperature at which the thermoplastic is malleable, so as to obtain a tape formed by bringing the yarns together so as to be touching, thereby creating transverse continuity;

the tape is cooled in order to consolidate the yarns by freezing the thermoplastic and its dimensional characteristics and its appearance are set in order to deliver the said composite tape of the invention.

According to one characteristic, the yarns that are brought together consist of continuous glass filaments and continuous thermoplastic filaments which are co-mingled.

According to another characteristic, the process consists in unreeling, from wound packages, a continuous yarn of reinforcing filaments and thermoplastic filaments and, while the yarns are being brought together in the form of a sheet, in regulating the tension in the yarns.

Advantageously, the yarns are stripped of any static electricity before the sheet passes into the heating zone.

According to another characteristic, the sheet is introduced into an additional heating zone after it has passed through the rotating impregnation device.

With regard to the apparatus for implementing the process, this is characterized in that it comprises:

means for entraining the continuous yarns consisting of reinforcing filaments and of thermoplastic filaments and means for bringing the said continuous yarns into the form of a sheet;

means for heating the said sheet to a temperature reaching at least the melting point of the thermoplastic but not the softening temperature of the reinforcing filaments;

a rotating device for impregnating the heated sheet so as to distribute the molten thermoplastic uniformly and guarantee that the reinforcing filaments are completely impregnated by the latter;

a device for shaping and centring the sheet so as to convert it into a tape;

a calender for cooling the tape, making it possible to freeze the thermoplastic and to consolidate the yarns and form the final tape.

According to one characteristic, the apparatus comprises additional heating means so as to keep the thermoplastic of the sheet malleable after the latter has passed through the impregnation device.

According to another characteristic, the means of the apparatus for bringing the yarns together consist of a comb, the tines of which produce a uniformly-spaced parallel alignment of the yarns.

According to another characteristic, the impregnation device comprises three heated rotating rolls which are arranged in a triangular configuration and between which the sheet runs, the roll separation height being adapted in order to apply suitable pressure to the surface of the sheet.

Advantageously, each roll has a blade for scraping off the molten thermoplastic deposited on the roll after the sheet has passed.

According to another characteristic, the shaping and centring device comprises a lower roller and an upper roller which are offset, one above the other, and rotating in opposite directions, the upper roller being in the form of a hyperboloid, and the sheet being concentrated around the central running axis as it passes between the two rollers in order to deliver a tape constituting a mutually contiguous association of yarns.

Advantageously, the cooling calender of the apparatus consists of two rotating cooling rolls which are arranged one above the other and which do not have guiding edges, the calender thus giving the composite tape its final shape.

Preferably, the cooling calender includes, downstream of the rolls, a bath in which the running composite final tape is immersed.

Further features and advantages will now be described with regard to the drawings in which:

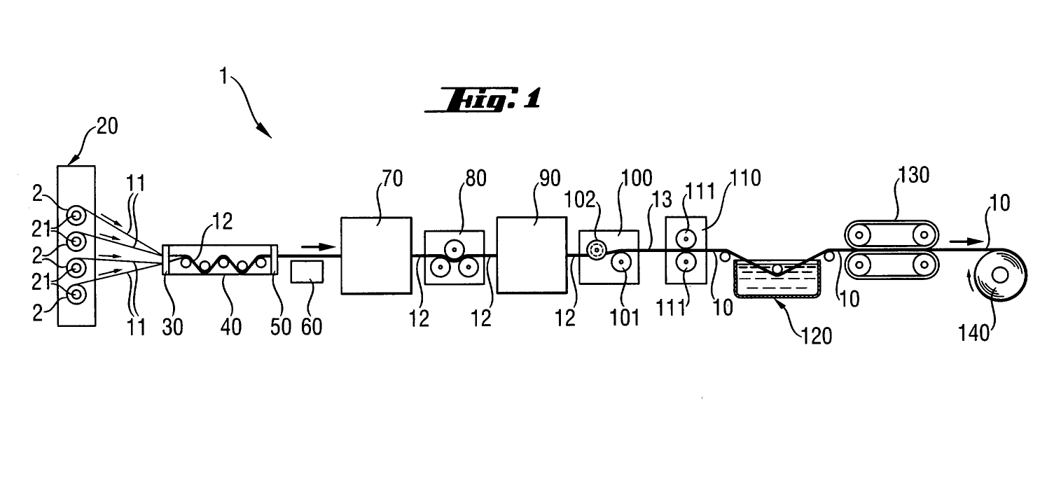

FIG. 1 is a schematic side view of the apparatus for manufacturing a tape according to the invention;

FIGS. 2 to 5 are perspective views of certain parts of the apparatus in FIG. 1, respectively of a device for regulating the tension in the yarns, of the rotating impregnation device, of the shaping and centring device and of the cooling calender.

The apparatus 1 seen in FIG. 1 allows manufacture of a tape 10 according to the invention, which has a constant thickness and consists of a multiplicity of parallel yarns 11 brought together so as to be mutually contiguous. Each yarn, sold by Vetrotex under the brand name TWINTEX® and manufactured according to the process described in Patent EP 0,599,695, consists of glass filaments and of filaments of a thermoplastic organic material, of the polyolefin or polyester type, which are intimately comingled.

The manufacturing apparatus 1 comprises, in the form of a line and going from the upstream end to the downstream end, a creel 20 provided with several wound packages 2 of yarn 11, an eyeletted plate 30, a device 40 for regulating the tension in the yarns, a comb 50, a device 60 for removing static electricity, a first oven 70, an impregnation device 80, a second oven 90, a smoothing and centring device 100, a calender 110, a cooling bath 120 and a caterpillar haul-off 130.

The creel 20 is of the unreeling type. Its purpose is to unreel the yarn 11 from each package 2. It is composed of a frame provided with horizontal rotating spindles 21, each supporting a package 2.

As a variant, it is possible to use a pay-out creel, but this introduces a twist into the yarn which is not constant, ranging from one turn per 50 cm to one turn per 1 m. This twist has the drawback of limiting the minimum thickness of the finished tape, it not being possible for this to go below 0.3 mm in the case of packages of 982 tex yarn.

Furthermore, this twist favours entanglement of the yarns as they run along the tape manufacturing line, thereby causing knots and/or non-parallel and non-taut yarns 11 in the tape once it has been formed, resulting in a reduction in the mechanical properties of the tape as finished product.

Consequently, it will be preferred to use an unreeling-type creel, especially for producing a small tape thickness (of less than 0.2 mm). However, in this case it proves to be necessary to provide a regulating device, referenced 40 in FIGS. 1 and 2.

This device 40 makes it possible to adjust the overall level of tension in the sheet of yarns.

The eyeletted plate 30, which can also be seen in FIG. 2, lies in a vertical plane parallel to the rotating spindles 21 of the creel. The eyeletted plate allows the yarns 11, each of which passes through an eyelet 31 in order to be guided towards the tension-regulating device 40 at an angle appropriate to the desired tension, to be grouped together. The eyelets 31 are made, in a known manner, of a ceramic in order to prevent the yarns from being damaged as they pass through them.

The tension-regulating device 40 which is illustrated in FIG. 2 is combined with the eyeletted plate 30. It comprises a series of cylindrical bars 41 arranged in a staggered configuration one above another, the yarns 11 coming from the eyeletted plate 30 travelling over and under these bars so as to define identical sinusoids, the amplitude of which influences the tension in the yarns. The height of the bars can be adjusted so as to be able to modify the amplitude of the sinusoids, an increased amplitude imposing a higher tension in the yarns.

The bars are advantageously made of brass or of a ceramic in order to limit the static electricity phenomena induced by the rubbing of the yarns.

Placed at the exit of the device 40 is a comb 50 whose tines 51 group the yarns 11 together into a uniformly-spaced parallel alignment in order to obtain a sheet 12 in the form of bundles of yarns.

Installed between the comb 50 and the entrance of the first oven 70 is an electrical device 60 serving to remove any static electricity with which the yarns 11 might be charged, so as to prevent the said yarns from bulking which, otherwise, would cause them to degrade in the oven 70.

The first oven 70 and likewise the second oven 90 operate by a convection of hot air. They could just as well be infrared ovens.

By passing through the first oven 70, the sheet 12 is heated to a temperature such that on leaving the oven the sheet has a temperature high enough to reach the melting point of the thermoplastic of the yarns 11 so that the molten thermoplastic sticks together and is embedded in the glass filaments of the entire sheet 12.

Between and outside the ovens 70 and 90 there is a rotating impregnation device 80 which flattens the sheet 12 so as to expel the air contained between the yarns, distribute the molten thermoplastic uniformly over the width of the sheet and guarantee that the glass filaments are completely impregnated by the thermoplastic.

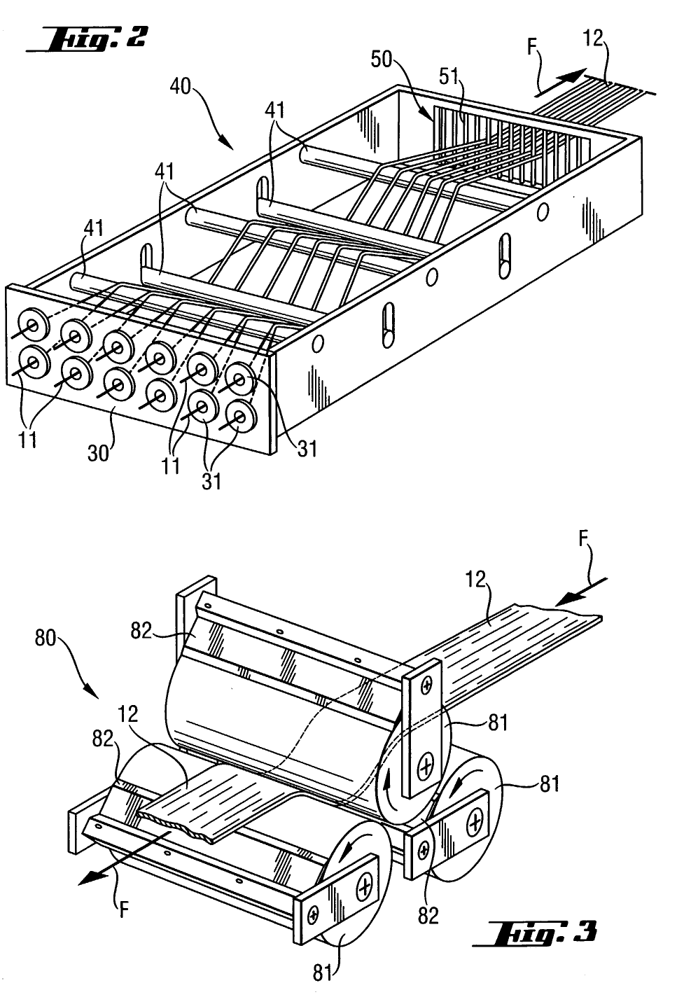

The rotating impregnation device 80, which can be seen in FIG. 3, consists of three mutually parallel rolls 81 arranged in a triangular configuration so as to have two lower rolls and one upper roll. The rolls are heated and reach a temperature high enough to maintain the thermoplastic of the sheet in a malleable state.

The rolls 81 rotate, the lower ones rotating in the positive direction with respect to the running direction F of the sheet 12 while the upper one rotates in the opposite direction, the rotation speeds being identical and corresponding to that at which the sheet runs.

The height of the upper roll can be adjusted in order to apply pressure to the sheet 12 high enough to ensure that the glass is impregnated by the thermoplastic.

Since the rolls 81 are in contact with the sheet, a film of thermoplastic is rapidly deposited onto their surfaces. Advantageously, the said rolls each have a blade 82 whose action is to scrape their surfaces and whose purpose is at the same time to prevent the formation of any spurious winding of the glass filaments and to help in achieving homogeneous distribution of the molten thermoplastic along the length of the tape. Thus, should there be an excessively thick film on each roll, this excess is used to supplement the encapsulation of the glass filaments which might be insufficiently coated.

The inclination of the blades 82 can be adjusted so as to optimize their effectiveness.

As a variant, for the same purpose of regulating the distribution of thermoplastic, instead of using the blades 82 the three rolls are driven at a slightly lower speed of rotation than the speed at which the sheet runs. This solution means that not only do the rolls 82 have to be driven but also that a speed control mechanism has to be installed.

The temperature setting of the second oven 90 is such that the thermoplastic of the running sheet remains malleable.

Note that it would be conceivable to use a single oven in which the impregnation device 80 would be housed, the impregnation device being able to withstand the temperature of the oven.

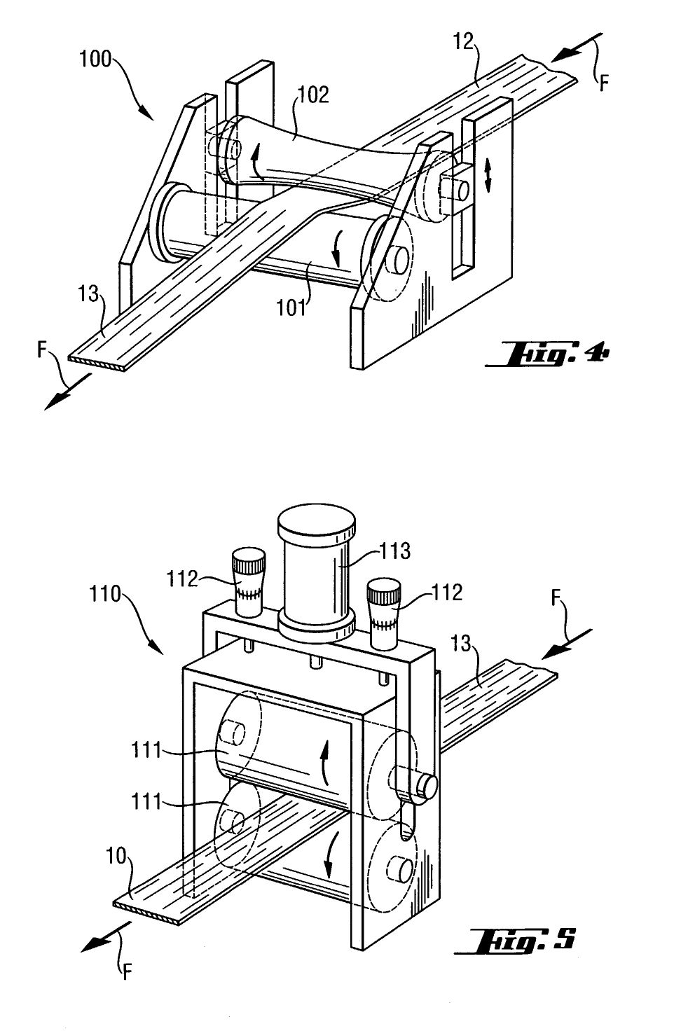

Placed at the exit of the second oven is a shaping and centring device 100 which, as illustrated in FIG. 4, comprises a cylindrical lower roller 101 and a hyperboloidal upper roller 102 which is slightly offset upstream with respect to the vertical through the lower roller, both rollers rotating and being heated in order to maintain the temperature at which the thermoplastic of the sheet 12 is malleable.

The purpose of the device 100 is to convert the sheet 12 into a tape 13 of constant thickness formed by bringing the yarns 11 together so as to be touching, in order to create transverse continuity in the said tape. Thus, the device 100 concentrates the sheet around the central axis of the line in order to reduce its width, which had been increased during its passage through the impregnation device 80, and recentres the sheet with respect to the central axis of the manufacturing line in order to suitably guide the tape downstream towards the calender 110.

The gathering and guiding towards the centre is achieved by the hyperboloidal shape of the upper roller 102 which, by adjusting its height, also allows light pressure to be applied to the upper surface of the sheet in order to concentrate it.

The counter rotation of the rollers 101 and 102 firstly prevents the thermoplastic from drying and secondly prevents it from accumulating, which could impair the uniformity of its distribution and consequently the thickness of the tape.

A calender 110, which can be seen in FIG. 5, is located downstream of the device 100 for the purpose of giving the tape 13 its final dimensional characteristics and its final appearance, so as to have a finished tape 10. The calender 110 adjusts the final thickness of the tape and at the same time cools it in order to freeze the thermoplastic, giving it a smooth surface appearance.

The calender consists of two counter rotating rolls 111 arranged one above the other and made to rotate by the tape running through them.

The two rolls 111 are cooled by internal circulation of water so as to freeze the thermoplastic and consolidate the yarns.

The thickness of the tape 10 is accurately controlled by the gap set between the two rolls using adjustable stops 112. A pneumatic cylinder 113 provides the pressure to be applied to the surface of the tape in order to even out all the thickness variants that might occur. It thus fulfils the role of locking the position of the adjustable stops 112.

It should be emphasized that the calender 110 does not have any guiding edges which, in the known calendering devices, make it possible to impose a width on the element to be calendered. This is because, in the invention, the width is defined by the number of yarns 11 used for manufacturing the tape. The absence of edges has the advantage of not shearing the yarns.

The final cooling of the tape is achieved by means of the water bath 120, placed after the calender 110, and in which the running tape 10 is immersed.

Installed beyond this bath is a caterpillar haul-off 130 which constitutes, in a known manner, a means of entraining the yarns and the tape, by exerting a tensile force all along the line. It sets the pay-out speed and the run speed of the sheet and then of the tape.

Finally, the manufacturing apparatus 1 may include, at the end of the line, a winder 140 intended to wind the tape in order to form a reel, so as to make it easier to store it.

The process for manufacturing the tape according to the invention will now be described. The example given below produces a glass/polyethylene composite tape with a width of 90 mm and a thickness of 0.2 mm, its void content being less than 0.2%.

The start-up of the process begins by manually pulling each yarn 11 off the packages 2 and manually taking it as far as the haul-off 130 where each yarn is then held clamped, all the yarns passing through the various devices described above. In this example of application, there are 28 rovings of glass/polyethylene co-mingled composite yarn having the trademark Twintex®, the 982 tex overall linear density of which comprises 60% glass by weight.

The ovens 70 and 90 as well as the heating elements of the apparatus 1 are raised in temperature so as to reach the following temperatures:

oven 70: 370° C.;

oven 90: 280° C.;

rotating rolls of the impregnation device 80: 290° C;

rollers of the shaping and centring device 100: 270° C.

The haul-off 130 is switched on and payout from the packages 2 starts.

The yarns 11 pass through the eyelets 31, then astride the bars in the device 40 and are brought together through the tines of the comb 50 in order to form, at the exit, the sheet 12 of parallel yarns.

The sheet 12 then meets the device 60 which removes any static electricity.

Next, the sheet enters the first oven 70 so that the thermoplastic reaches its melting point. Thereafter, it passes between the heated rolls of the device 80 which make it possible for it to be rolled, expelling the air, and to uniformly distribute the thermoplastic which thus encapsulates the glass filaments. We should point out that the amount of thermoplastic does not have to be metered since it is directly incorporated into the raw material of the tape by it being co-mingled with the glass filaments. The temperature of the sheet, after it has passed through this device 80, reaches 190° C.

The sheet 12 then passes through the second oven 90 in order to maintain the thermoplastic in a malleable state so that, on leaving the oven, it runs between the rollers 102 of the shaping and centring device 100, in order to convert it into a tape 13 which is shaped by closing up the yarns against each other and placing them so that they touch each other. After shaping, the tape has a temperature of 210° C.

Next, the tape 13 passes between the rolls 111 of the cold calender 110 in order to give it its final shape, by freezing the thermoplastic and consolidating the yarns. The tape 10 of the invention is obtained with a constant thickness and a smooth appearance. The tape has a temperature of 100° C. on leaving the calender.

In order to facilitate and speed up the cooling of the entire tape 10, the latter is immersed in a water bath 120 and becomes, on leaving it, its temperature being 30° C., a strong product sufficiently flexible to be wound up by means of a winder 140 in the form of a reel, for ease of storage, transportation and use.

1. Process for manufacturing a composite tape (10) based on reinforcing fibres and on a thermoplastic organic material, consisting in bringing together and in consolidating a multiplicity of continuous yarns (11), characterized in that:
yarns (11) based on thermoplastic and reinforcing fibres are entrained and brought together in a parallel manner in the form of a sheet (12);
the said sheet (12) is made to enter a zone in which it is heated to a temperature reaching at least the melting point of the thermoplastic without reaching the softening temperature of the reinforcing fibres;
the sheet (12) is made to pass through a rotating impregnation device (80), while maintaining its temperature at a temperature at which the thermoplastic is malleable, in order to distribute the molten thermoplastic uniformly and guarantee, that the reinforcing fibres are completely impregnated by the latter;
the sheet (12) is introduced into a shaping and centring device (100), while maintaining its temperature at a temperature at which the thermoplastic is malleable, so as to obtain a tape (13) formed by bringing the yarns (11) together so as to be touching, thereby creating transverse continuity;
the tape (13) is cooled in order to consolidate the yarns by freezing the thermoplastic and its dimensional characteristics and its appearance are set in order to deliver the said composite tape (10).

2. Process according to claim 1, characterized in that the yarns (11) that are brought together consist of continuous glass filaments and continuous thermoplastic filaments which are co-mingled.

3. Process according to claim 1 or 2, characterized in that it consists in unreeling, from wound packages, a continuous yarn of reinforcing filaments and thermoplastic filaments and, while the yarns are being brought together in the form of a sheet, in regulating the tension in the yarns.

4. Process according to claim 1, characterized in that the yarns (11) are stripped of any static electricity before the sheet (12) passes into the heating zone.

5. Process according to claim 1, characterized in that the sheet (12) is introduced into an additional heating zone after it has passed -through the rotating impregnation device (80).

6. Process according to claim 1, characterized in that, at the end of the manufacturing line, the tape (10) is wound up in the form of a reel for storing it.

7. Apparatus for implementing the process according to any one of claims 1 to 6, characterized in that it comprises:
means (130) for entraining the continuous yarns (11) consisting of reinforcing filaments and of thermoplastic filaments and means (50) for bringing the said continuous yarns into the form of a sheet (12);
means (70) for heating the said sheet (12) to a temperature reaching at least the melting point of the thermoplastic but not the softening temperature of the reinforcing filaments;
a rotating device (80) for impregnating the heated sheet so as to distribute the molten thermoplastic uniformly and guarantee that the reinforcing filaments are completely impregnated by the latter;
a device (100) for shaping and centring the sheet (12) so as to convert it into a tape (13);
a calender (110) for cooling the tape (13), making it possible to freeze the thermoplastic and to consolidate the yarns (11) and form the final tape (10).

8. Apparatus according to claim 7, characterized in that it comprises additional heating means (90) so as to keep the thermoplastic of the sheet (12) malleable after the latter has passed through the impregnation device (80).

9. Apparatus according to claim 8, characterized in that the two heating means (70, 90) are ovens.

10. Apparatus according to claim 7, characterized in that the means (50) for bringing the yarns together consist of a comb, the tines (51) of which produce a uniformly-spaced parallel alignment of the yarns (11).

11. Apparatus according to claim 7, characterized in that the impregnation device (80) comprises three heated rotating rolls (81) which are arranged in a triangular configuration and between which the sheet (12) runs, the roll separation height being adapted in order to apply suitable pressure to the surface of the sheet.

12. Apparatus according to claim 11, characterized in that each roll (81) has a blade (82) for scraping off the molten thermoplastic deposited on the roll after the sheet has passed.

13. Apparatus according to claim 7, characterized in that the shaping and centring device (100) comprises a lower roller (101) and an upper roller (102) which are offset, one above the other, and rotating in opposite directions, the upper roller being in the form of a hyperboloid, and the sheet (12) being concentrated around the central running axis as it passes between the two rollers in order to deliver a tape (13) constituting a mutually contiguous association of yarns.

14. Apparatus according to claim 7, characterized in that the cooling calender (110) consists of two rotating cooling rolls which are arranged one above the other and between which the tape (13) runs and which do not have guiding edges, the calender giving the composite tape (10) its final shape.

15. Apparatus according to claim 14, characterized in that the cooling calender (110) includes, downstream of the rolls, a bath (120) in which the running composite final tape (10) is immersed.

16. Apparatus according to claim 7, characterized in that means (40) for regulating the tension in the yarns (11) are provided upstream of the means (50) for bringing the yarns together.

17. Apparatus according to claim 7, characterized in that an antistatic device is provided upstream of the heating means (70).

18. Apparatus according to claim 7, characterized in that it includes, at the end of the manufacturing line and downstream of the entrainment means (130), a winder (140) allowing the tape (10) to be wound in the form of a reel.

19. Tape obtained according to the process of claim 1, characterized in that it constitutes a strong flexible product of smooth surface appearance, having a thickness of less than 0.2 mm and a void content of less than 0.2%.
